(19) United States
(12) Patent Application Publication
(10) Pub. No.: US 2009/0124443 A1
(43) Pub. Date: May 14, 2009

(54) Belt drive

(76) Inventor: Hermann Stief, Emskirchen (DE)

Correspondence Address: HEDMAN & COSTIGAN P.C., 1185 AVENUE OF THE AMERICAS, NEW YORK, NY, 10036, US

(21) Appl. No.: 11/989,311

(22) PCT Filed: Jul. 8, 2006
(86) PCT No.: PCT/EP2006/006701

§ 371 Date: Jan. 23, 2008

(30) Foreign Application Priority Data
Jul. 29, 2005 (DE) 10 2005 035 572.2

(51) Int. Cl. F16H 7/14

(52) U.S. Cl. 474/167

(57) ABSTRACT

A belt drive of an internal combustion engine, wherein the belt pulleys are connected by an elastomer belt, for creating a mounting position, the belt pulley can be eccentrically pivoted about the screw connection after the screw connection has been removed whereby due to the diminishing distance between the axes of the belt pulleys, the placing of the elastomer belt in the required position is simplified.

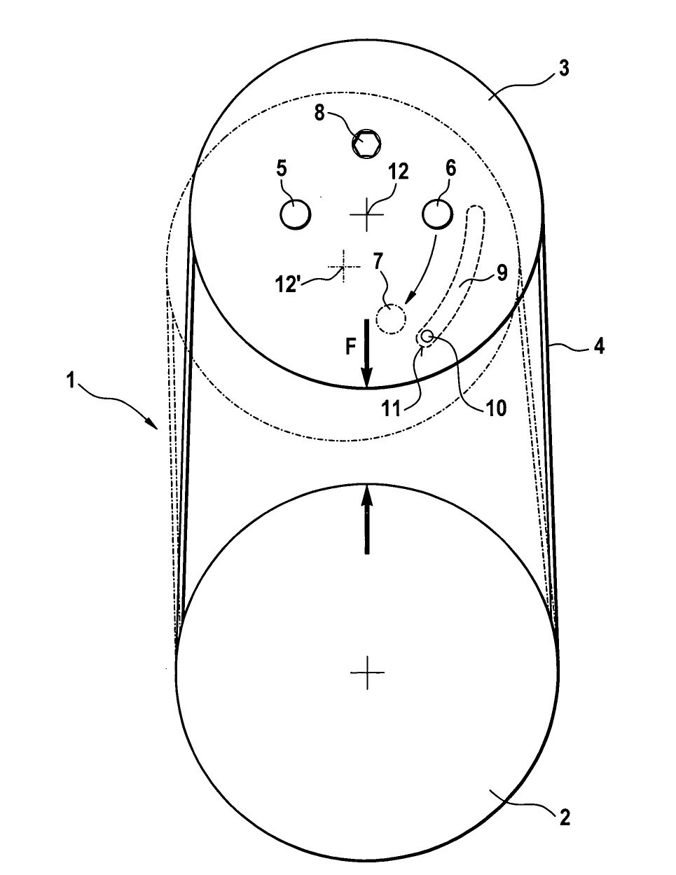

### FIELD OF THE INVENTION

The subject matter of the invention is a belt drive for internal combustion engines, said belt drive comprising a driven wheel constituted by a first belt pulley and at least one driving wheel constituted by a second belt pulley, said first and second belt pulleys being connected by a traction element configured as an elastomer belt, and at least one of said first and second belt pulleys comprising a disengageable fixing means.

### BACKGROUND OF THE INVENTION

During operation, belt drives, that can also be designated as traction drives, require a pre-stressed traction element for assuring a low slip and thus wear-resistant drive function.

Many types of belt drives comprise a separate tensioning device that automatically re-tightens the traction element, i.e. the belt, during the entire operating life of the traction element. These mostly very complex devices cause high manufacturing costs and, further, necessitate a larger design space for the installation of the belt drive.

Besides this, belt drives without separate tensioning devices are also known whose traction element is an elastomer belt. In such belt drives the problem can occur that the elastomer belt has to be relatively strongly expanded during assembly to permit the belt to be mounted on the belt pulley of the belt drive. This can result in an over-expansion of the elastomer belt and can cause a preliminary damage to the elastomer belt, so that no adequate pre-stress can be produced by the belt. This leads to increased slip and wear that can result in a premature failure of the traction element, i.e. of the elastomer belt and the belt drive. Moreover, such a mounting procedure of the elastomer belt is complicated, time-consuming, requires special tools and causes high overall costs.

The internal combustion engine for the Volkswagen car Model “Bug” comprises a belt drive between a belt pulley associated to the crankshaft and the belt pulley of the generator. For mounting the traction element configured as a V-belt, one half of the divided belt pulley that is associated to the dynamo is removed, so that the belt can be mounted free of stress. The pre-stress of the belt can be influenced by spacers between the belt pulley halves that can be inserted before mounting the second half of the belt pulley.

DE 38 21 369 C2 discloses a device for limited expansion for a pre-stretching of the traction element. The belt to be mounted is at first received in a separate tensioning device and subjected to dynamic loading so as to effect a pre-stretching. Following this, the belt is installed in the warmed-up operative state into the pre-defined construction space, i.e. into the belt drive of the vehicle. A drawback of this prior art is the high total work of assembly and the additional costs due to the separate stretching device.

### OBJECT OF THE INVENTION

Taking into consideration the drawbacks of known solutions, it is an object of the invention to provide a belt drive which does not comprise a separate tensioning device and enables a simple mounting of the elastomer belt without special tools while enhancing the operating life of the elastomer belt.

This and other objects and advantages of the invention will become obvious from the following detailed description.

### SUMMARY OF THE INVENTION

The subject matter of the invention is a belt drive of an internal combustion engine, which belt drive comprises a driven wheel and at least one driving wheel, each of which wheels is constituted by a belt pulley. These belt pulleys are connected by a traction element configured as an elastomer belt, at least one of said belt pulleys comprising a disengageable fixing means. For achieving its objects the invention proposes that at least one of the belt pulleys is arranged for limited displacement during mounting. This type of fixing of one of the belt pulleys has the advantage that, while mounting the elastomer belt on the belt pulley arranged for limited displacement, the traction element, i.e. the elastomer belt does not need to be expanded. The displaceable belt pulley enables the belt to be mounted without any problem on all the belt pulleys included in the belt drive. Following this, a tensioning of the elastomer belt is achieved through the displaceable, pivotable belt pulley, so that the pre-stress of the elastomer belt necessary for the operative state is produced.

This inventive measure can advantageously be implemented without a detrimental, impermissible expansion or pre-stretching of the elastomer belt, so that it is possible to achieve a longer operating life of the elastomer belt and of the traction belt drive connected thereto. This mounting of the elastomer belt can be advantageously executed at low cost. Compared to prior art solutions with complex tensioning systems, stretching devices or complex mounting procedures, the invention enables a rapid and simple-to-execute mounting of the traction element configured as an elastomer belt. The invention further guarantees an absolutely gentle handling of the elastomer belt which has a beneficial effect on the operating life, so that a cost advantage is also achieved.

Further advantageous developments of the invention are the subject matter of the dependent claims that are treated below.

The inventive, displaceably fixed belt pulley is preferably fixed by two screw connections detachably on an associated auxiliary unit. After removal of one of the screw connections and a limited loosening of the other screw connection, the arrangement of the invention enables the belt pulley to be eccentrically turned about the limitedly loosened screw connection. This position of the belt pulley simplifies the mounting of the belt on all the belt pulleys of the belt drive. After the belt has been placed around the pulleys, the eccentrically displaced belt pulley is rotated into the operating position, so that the elastomer belt is pre-stressed before the belt pulley is fixed for the operating state with the help of the other screw connection.

For achieving the largest possible displacement of the displaceably arranged belt pulley, it is advantageous to orient the limitedly loosened screw connection, so that it corresponds to the direction of force of the belt pulley defined by the elastomer belt. In this way, on the one hand, a maximum displacement of the belt pulley is achieved and, on the other hand, an automatic rotation of the belt pulley into the direction of force defined by the elastomer belt is prevented when the elastomer belt is mounted in place.

This procedure can be adopted independently of the number of screw connections and all screw connections with the exception of one screw connection must generally be disengaged for enabling a pivoting of the belt pulley relative to the fixing or mounting surface.

The invention further provides an adjusting element with which the displaceable belt pulley can be displaced into the operating position after the traction element has been mounted. The adjusting element is configured such that, through application of a slight force, the belt pulley can be pivoted about the limitedly loosened screw connection manually into the operating position after the traction element has been mounted.

An appropriate adjusting element is, in particular, an external tool that engages preferably positively into a tool reception of the belt pulley for displacing the belt pulley through application of a slight force. The tool is preferably an angled lever arm ending in a polygonal profile that engages positively into a recess, configured, for instance, as a hexagonal socket in the belt pulley.

According to a further proposition of the invention, a displaceably arranged belt pulley comprises a guide slot. This guide slot extends with a radius relative to the limitedly loosened screw connection and is arranged on the belt pulley. In the operating state, an axially projecting extension or toe of the associated auxiliary unit cooperating with the guide slot engages positively into the guide slot.

Alternatively, the guide slot may also be arranged on the auxiliary unit and an axially projecting extension or toe of the belt pulley associated thereto can engage positively into the guide slot in the operating state.

For achieving a defined mounting position of the displaceable belt pulley, the guide slot comprises at least one end stop. The guide slot together with the end stop enables an automated mounting of the belt and a subsequent rotation of the belt pulley relative to the associated auxiliary unit.

According to another provision of the invention, an error of mounting is prevented by providing a mark on the screw connection that is to be limitedly loosened and constitutes a pivot of the displaceable belt pulley. This measure serves to prevent a confusion of the screw connection that forms an eccentric pivot of the belt pulley for the mounting of the elastomer belt.

In a further development of the invention, for simplifying mounting of the traction element configured as an elastomer belt, the belt drive comprises two displaceable belt pulleys. This measure is particularly suitable for a belt drive comprising a plurality of belt pulleys to some of which access is only possible with some difficulty. By the provision of two displaceable belt pulleys in the belt drive, the positioning, i.e. the mounting of the elastomer belt is greatly simplified.

### BRIEF DESCRIPTION OF THE DRAWING

The sole FIGURE is a schematic representation of a belt drive of the invention showing a belt pulley in a mounting position and in an operating position.

### DETAILED DESCRIPTION OF THE DRAWING

The belt drive 1 comprises two belt pulleys 2, 3 that are connected through a traction element in form of an elastomer belt 4. Driving is effected through the belt pulley 2 that is configured as a driven wheel and is preferably connected to the crankshaft of an internal combustion engine, not illustrated. The further belt pulley 3 constitutes the driving wheel that is connected, for instance, to the water pump of the internal combustion engine or to another auxiliary unit. The traction element configured as an elastomer belt 4 is a permanently elastic, pre-stressed traction element, so that no separate tensioning system is required for the belt drive 1 for guaranteeing a substantially slip-free and thus wear-resistant belt drive 1.

To assure a simple mounting of the elastomer belt 4, the invention provides a displaceable belt pulley 3. This measure is realized through an eccentric displacement of the belt pulley 3 which results in a mounting position in which the elastomer belt 4 can be placed in position in a simple manner. In the illustrated example of embodiment, the belt pulley 3 is detachably fixed to the associated auxiliary unit through screw connections 5, 6. For mounting, the screw connection 6 is removed, so that the belt pulley 3 can be eccentrically rotated about the remaining, limitedly loosened screw connection 5.

For reaching its mounting position, the belt pulley 3 is rotated in the direction of the arrow, i.e. in clockwise direction, the screw connection 5 forming an axis of rotation for the belt pulley 3. The position of the screw connection 6, i.e. of its reception bore is thus displaced into the end position 7 identified by a dot-dash line. For making the mounting position more clear, the belt pulley 3 and the elastomer belt 4 are also shown in dot-dash lines corresponding to the end position 7. The reduced distance between the axes of the belt pulleys 2, 3 in the mounting position enables a simple placing of the elastomer belt 4 in the required position. At the same time, the center point 12 of the belt pulley 3 is displaced into the position 12′ likewise identified by a dot-dash line.

As a mounting aid, the belt pulley 3 comprises a tool reception 8 that is configured as a polygonal profile, preferably as a hexagon. The tool reception 8 is intended for a separate tool whose end has a profile corresponding to the polygonal profile of the tool reception 8. A suitable tool for this purpose is, for instance, a hexagon socket screw key with which, after the elastomer belt 4 has been placed in position, the belt pulley 3 can be pivoted in a simple manner from mounting position shown by the dash-dot line into the operating position. According to a further feature of the invention, a guide arrangement comprising a guide slot 9 and a projecting pin 10 is provided on the belt pulley 3 and the associated auxiliary unit. This guide arrangement comprises, in the region of the support surface of the belt pulley 3 on the associated auxiliary unit, a curved guide slot 9 extending with a radius relative the screw connection 5, into which recess a projecting pin 10 connected to the belt pulley 3 engages positively. An end stop 11 of the guide slot 9 defines the end position, i.e. the mounting position of the belt pulley 3.

For mounting the elastomer belt 4, it is advantageous to first orient the belt pulley 3 such that the loosened screw connection 5 or 6 corresponds to a direction of the force “F” that is exerted by the elastomer belt 4 on the belt pulley 3 in the installed state. With this measure, an automatic rotation of the belt pulley 3 during mounting is prevented.

### LIST OF REFERENCE NUMERALS

1 Belt drive
2 First belt pulley
3 Second belt pulley
4 Elastomer belt
5 Screw connection
6 Screw connection
7 End position
8 Tool reception
9 Guide slot
10 Pin
11 End stop
12 Center point

1. A belt drive of an internal combustion engine, said belt drive comprising a driven wheel constituted by a first belt pulley and at least one driving wheel constituted by a second belt pulley, said first and second belt pulleys being connected by a traction element configured as an elastomer belt, at least one of said first and second belt pulleys comprising a disengageable fixing means, wherein at least one of said first and second belt pulleys can be arranged for limited displacement during mounting of the elastomer belt.

2. A belt drive of an internal combustion engine of claim 1, wherein the second belt pulley comprises at least two screw connections that constitute the fixing means, for mounting the elastomer belt, all screw connections are removed with exception of one screw connection that is only loosened, and the second belt pulley is pivoted eccentrically about the one only loosened screw connection.

3. A belt drive of an internal combustion engine of claim 1, wherein during mounting of the elastomer belt, the second belt pulley is adjusted, so that the loosened screw connection corresponds to a direction of force defined by the elastomer belt.

4. A belt drive of an internal combustion engine of claim 1, wherein the second belt pulley can be displaced by pivoting by an external adjusting means.

5. A belt drive of an internal combustion engine of claim 4, wherein the pivotable belt pulley comprises a tool reception intended for receiving an external tool.

6. A belt drive of an internal combustion engine of claim 4, wherein the belt pulley can be adjusted with a tool comprising a hexagonal profile.

7. A belt drive of an internal combustion engine of claim 1, wherein the displaceable belt pulley comprises a guide slot.

8. A belt drive of an internal combustion engine of claim 7, wherein an auxiliary unit associated to the belt pulley comprises a guide slot.

9. A belt drive of an internal combustion engine of claim 1, wherein an auxiliary unit associated to the belt pulley comprises a guide slot into which a pin arranged on the belt pulley engages positively.

10. A belt drive of an internal combustion engine of claim 7, wherein the guide slot comprises at least one end stop.

11. A belt drive of an internal combustion engine of claim 1, wherein the screw connection intended to form a pivot of the belt pulley for mounting of the elastomer belt comprises an identifying mark.

12. A belt drive of an internal combustion engine of claim 1, wherein two belt pulleys are arranged for limited displacement during mounting.
